(19) United States
(12) Patent Application Publication
(10) Pub. No.: US 2020/0149225 A1
(43) Pub. Date: May 14, 2020

(54) PeelTowel

(71) Applicants: Prarthana Prashanth, Aurora, IL (US); Srikant Lokesh, Naperville, IL (US); Milind Sagaram, Aurora, IL (US)

(72) Inventors: Prarthana Prashanth, Aurora, IL (US); Srikant Lokesh, Naperville, IL (US); Milind Sagaram, Aurora, IL (US)

(21) Appl. No.: 16/679,204

(22) Filed: Nov. 10, 2019

Related U.S. Application Data
(60) Provisional application No. 62/760,921, filed on Nov. 14, 2018.

(51) Int. Cl. D21H 27/00; D21H 11/12; D21H 11/14; A01N 65/36; A01N 65/08

(52) U.S. Cl. CPC D21H 27/002; D21H 11/12; A01N 65/08; A01N 65/36; D21H 11/14

(57) ABSTRACT

An antibacterial absorbent towel made from fruit peels. The towel includes fruit peels that contain Vitamin C, citric acid, and cellulose. Vitamin C and citric acid demonstrate antibacterial properties, and cellulose possesses water-absorbing qualities. The towel is easy to make and easy to use and increases access to hygiene in rural and poorer regions that lack access to expensive hygiene products. At the same time, the towel reduces paper wastage by utilizing typically discarded fruit peels. Due to its makeup, the towel is reusable and easily composted. Based on these factors, the towel is environmentally friendly unlike prior art. This towel aims to solve the issues of inaccessible hygiene, paper wastage, and peel wastage under one solution.

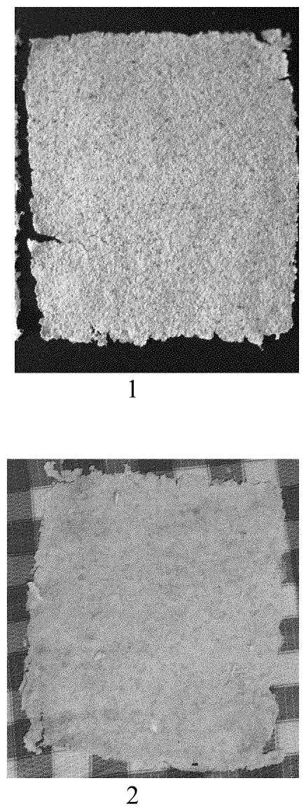

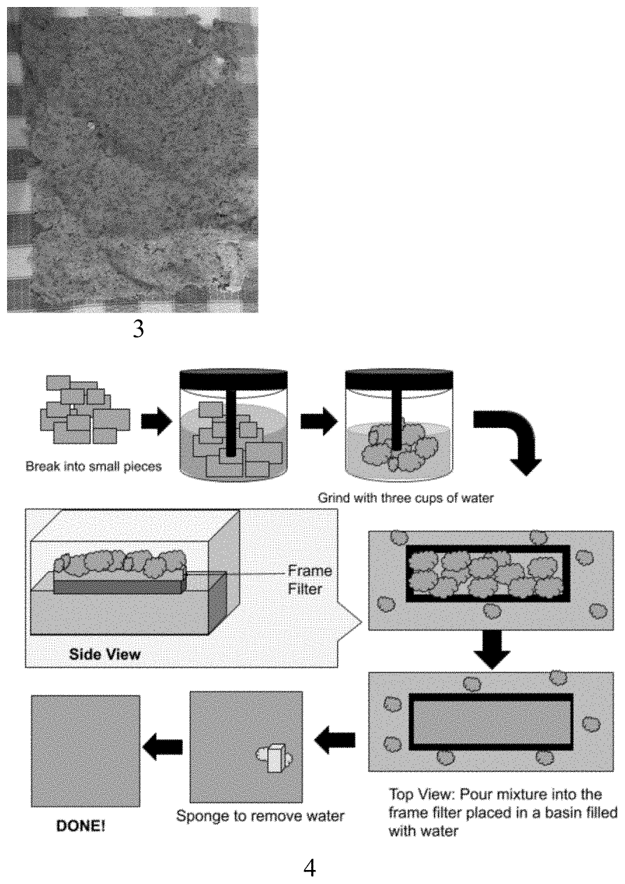

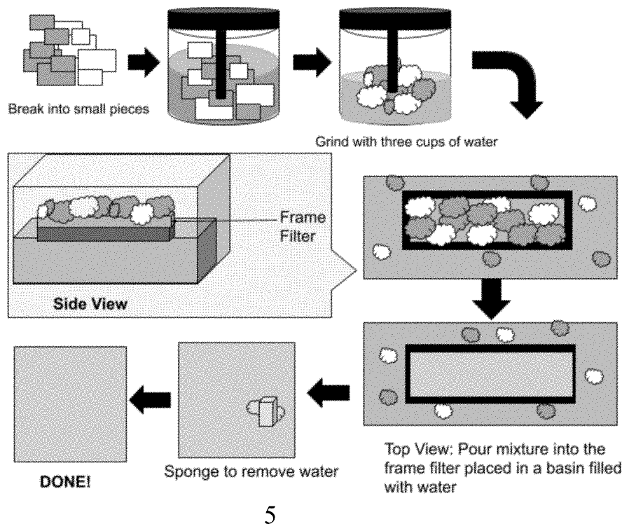

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND

### 1. Field of Invention

The present invention relates to hygiene products but more specifically it relates to an antibacterial and water-absorbent towel made from fruit peels increasing access to hand hygiene and reducing wastage.

### 2. Description of Related Art

The Center for Disease Control and Prevention (CDC) estimates that globally, 2.5 billion people lack access to adequate hygiene, which is 35% of the world's population. Current hygiene products including soaps and antiseptic wipes are often unaffordable and inaccessible to people living in rural or poorer regions. Furthermore, many hygiene products are unusable without running water that many of the world's regions lack or must conserve.

Additionally, the University of Southern Indiana states that the average American uses 680 pounds of paper a year. This is equivalent to seven trees indicating that the United States utilizes around 2,000,000,000 trees a year to produce paper alone. Many current hygiene products are made primarily of paper or wood pulp contributing to this wastage of paper. Some main products include paper towels and antiseptic wipes. These products are typically not reusable and in the long term are harming the environment.

Furthermore, the American Institute of Physics found that around 15.6 million tons of citrus peel waste is produced globally each year. Current hygiene products do not make use of the benefits fruit peels possess.

Current hygiene products also employ many chemicals and preservatives in order to increase the antimicrobial benefits or shelf life of the products. This is not environmentally friendly and may have unsaid side effects in the long term.

### BRIEF SUMMARY

In view of the disadvantages inherent in related art, the present invention utilizes the antibacterial and absorbent capabilities of fruit peels to increase access to hygiene and reduce wastage. Due to its simple makeup, the present invention is an eco-friendly, accessible, and affordable alternative to hygiene products, primarily antiseptic wipes and paper towels.

Research demonstrates that Vitamin C is effective in killing bacteria through its role in the Fenton Reaction. Furthermore, citric acid lowers the pH of bacterial environments hindering bacterial growth. Many fruit peels, especially citrus fruit peels, contain both Vitamin C and citric acid and therefore possess antibacterial properties. Furthermore, many fruit peels contain cellulose, a water-absorbing starch found in paper towels. For example, lime peels, orange peels, and kiwi peels possess all three of these qualities making them ideal for use in the present invention. Further investigation may reveal, more fruit peels that possess Vitamin C, citric acid, and cellulose.

The present invention has potential to improve hygiene in rural and poorer regions where running water or effective sanitation is inaccessible. In the United States, the present invention will prevent further harm to the environment by reducing paper wastage and reusing organic peel waste.

A primary object of the present invention is to provide an antibacterial and absorbent towel using typically discarded fruit peels.

A second object is to provide a towel that is all-natural and environmentally friendly that will overcome the drawbacks of prior art.

Another object is to provide a towel that is easily accessible to people in rural or poorer regions.

A further object is to provide a towel that can be used more than once and that is longer lasting than existing antiseptic wipes or paper towels.

An additional object is to provide a towel that can be easily decomposed and composted into the earth.

Other objects and advantages of the present invention will become obvious to the reader and it is intended that these objects and advantages are within the scope of the present invention.

This invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF DRAWINGS

Various other objects, features and attendant advantages of the present invention will become fully appreciated as the same becomes better understood when considered in conjunction with the accompanying drawings wherein:

1 is an image of the present invention made up of lime peels and discarded paper waste.
2 is an image of the present invention made up of orange peels and discarded paper waste.
3 is an image of the present invention made up of kiwi peels and discarded paper waste.
4 is a drawing of the process by which the present invention is made solely out of fruit peels is created.
5 is a drawing of the process by which the present invention is made using a combination of a binding agent and fruit peels.

### DETAILED DESCRIPTION OF INVENTION

The present invention utilizes the antibacterial and water-absorbent properties of fruit peels to generate an environmentally friendly, affordable, and accessible towel.

Turning now descriptively to the drawings, 1, 2, and 3 illustrate completed PeelTowels comprised of lime peels, orange peels, and kiwi peels respectively. Drawing 4 portrays the process of producing the PeelTowel utilizing only fruit peels, while drawing 5 illustrates this process utilizing another binding agent as well.

Creating the PeelTowel is a multiple step process as described in drawings 4 and 5. This process mainly differs from the process used to produce prior art in that it makes use of typically discarded fruit peels.

Before beginning the process, a plastic tote (2.5 ft by 2 ft by 1 ft) is filled with water until the water takes around 1/4^{th} of the tote's volume. Then, a frame filter is constructed using two 8 inch by 10 inch picture frames and an 8 inch by 10 inch piece of mesh. The glass covering and insides of both picture frames are removed so that all that remains is the external frame border. Then, using a hot glue gun, all four edges of the mesh piece are tightly glued to the back of one frame. The second frame is placed lightly on top of the mesh and this entire frame filter is placed on the surface of the tote's water.

Next, the pulp is produced. First, the fruit is washed under hot water. Then, the fruit is peeled by hand or by using a vegetable peeler. For some fruits, such as lime, a lime squeezer is used to remove the juice and retain only the peel. Then, the fruit peels are torn or cut into small pieces. These pieces are added to a blender along with 600 mL of water. The mixture is blended on high until a semi-solid consistency of pulp is formed.

This pulp is slowly poured into the center of the frame filter where only mesh is present. While the pulp is being poured, one person holds the top frame, which is not glued to the mesh, tightly. The entire filter is partially submerged in the water in order to spread the pulp out evenly over the mesh. The filter is then removed from the water, the top frame is lifted off, and all that remains is the pulp on the mesh and the bottom frame. The bottom frame is flipped over onto a cloth towel and sponges are used to removed water from the pulp. A hairdryer is also used to remove water from the pulp. What is left after separating the pulp from the mesh and frame is the PeelTowel.

As shown in drawing 5, this process can be manipulated by adding a binding agent. These additives must be added to the peels and water in the beginning of the procedure, before blending the mixture. If the additive is a larger item, such as recycled paper, it must be torn into smaller piece before being added. The rest of the procedure remains the same.

Using this procedure, peels from any singular fruit or peels from a combination of fruits can be used to create the PeelTowel. Additives can be added as well in varying concentrations. Three sample PeelTowels are shown in drawings 1, 2, and 3. Many variations are possible within the scope of the invention, which is intended to be defined by the following claims (and their equivalents) in which all terms are meant in their broadest reasonable sense.

We claim:

1. An absorbent towel comprising:
A said fruit peel or a combination of fruit peels in any proportion wherein fruit peels are dry, wet, or in any condition.

2. An absorbent towel as in claim 1, wherein said fruit peel or any fruit peel contains antibacterial properties.

3. An absorbent towel as in claim 1, wherein any fruit peel is a citrus fruit peel.

4. An absorbent towel as in claim 1, wherein any fruit peel is an orange fruit peel.

5. An absorbent towel as in claim 1, wherein any fruit peel is a lime fruit peel.

6. An absorbent towel as in claim 1, wherein any fruit peel is a kiwi fruit peel.

7. An absorbent towel as in claim 1, further comprising a said additive.

8. An absorbent towel as in claim 1, further comprising paper.

9. An absorbent towel as in claim 1, further comprising recycled paper.

10. An absorbent towel as in claim 8, wherein said fruit peel or fruit peels comprise of greater than 50% volume of all components the towel is comprised of.
